(19) United States
(12) Patent Application Publication
(10) Pub. No.: US 2004/0095344 A1
(43) Pub. Date: May 20, 2004

(54) Emotion-based 3-d computer graphics emotion model forming system

(76) Inventors: Katsuji Dojyun, Tokyo (JP); Takashi Yonemori, Tokyo (JP); Shigeo Morishima, Tokyo (JP)

Correspondence Address: BROWN & MICHAELS, PC, 400 M & T BANK BUILDING, 118 NORTH TIOGA ST, ITHACA, NY, 14850, US

(21) Appl. No.: 10/473,641

(22) PCT Filed: May 21, 2001
(86) PCT No.: PCT/JP01/04236

(30) Foreign Application Priority Data
Mar. 29, 2001 (JP) 2001-94872

(51) Int. Cl. G06T 15/00

(52) U.S. Cl. 345/419

(57) ABSTRACT

A system for forming a 3D computer graphics expression model based on emotional transition, which is provided in a computer device comprising input means, storage means, control means, output means, and display means, comprising: storage means for storing the last three layers of a five-layer neural network for expanding three-dimensional emotion parameters into n-dimensional expression synthesis parameters, three-dimensional emotion parameters in emotional space corresponding to basic emotions, and shape data that serves as a source for the formation of a 3D computer graphics expression model for expression synthesis; means for deriving emotion parameters in emotional space corresponding to specific emotions; and calculation means whereby, using data for the last three layers in a five-layer neural network having a three-unit middle layer, emotion parameters, which were derived by the emotional parameter derivation means, are input to the middle layer, and expression synthesis parameters are output at the output layer.

### TECHNICAL FIELD

The present invention is a system that uses a computer device to form a 3D graphic expression model based on emotion and a system that uses the same to create emotion parameters in a three-dimensional emotional space; the present invention relates to the construction of a system wherein n-dimensional expression synthesis parameters are compressed into emotion parameters, which are coordinate data in a three-dimensional emotional space, and to the use of the same for the purpose of forming expressions on target shape data by setting blend ratios for emotions, and for the purpose of varying expressions along a time axis.

### BACKGROUND ART

Conventionally, methods wherein facial movements are defined for various sites on a face, and facial expressions are produced by combining these, are widely used as methods of synthesizing facial expressions. However, defining movements for various facial sites is difficult work, and there is a possibility of defining unnatural movements.

For example, in JP-2001-034776-A, “Animation Editing System and Recording Medium Storing Animation Editing Program” art is described, which automatically creates animations comprising naturalized movements, using an animation creating device that creates animations by linking unit parts.

An animation editing system that assists in editing, wherein parts editing means link unit parts accumulated in a parts database, is provided with: common interface means for facilitating the exchange of information; first naturalization request means, which send a request for naturalization of an animation sequence resulting from the parts editing means to the common interface means; a naturalization editing device, which receives naturalization requests by way of the common interface and matches specified animation sequences to create naturalized animation sequences; and synthesis means, which combine naturalized animation sequences received by way of the common interface with the original animation sequence.

Furthermore, in JP-2000-099757-A, “Animation Creation Device, Method, and Computer Readable Recording Medium Storing Animation Creation Program” art is disclosed for simple editing of animation products, wherein character animation parts are used to smooth expressions and movements.

Recording means record human movements and expressions, divided into a plurality of frames, in an animation parts Parts Table, and record animation parts attribute values in the Parts Table. Input means input animation parts attribute values in response to progressive story steps. Computation means select animation parts from the storage means using attribute values input from the input means and create an animation according to the story.

All of these simply combine previously produced parts; the definition of movements for facial sites, in accordance with infinite variations in emotion, and the natural representation of changes in expressions is difficult work, so that unnatural movements tend to be defined. There was a problem in that it was only possible to make definitions within the confines of parts which had been prepared beforehand.

In order to solve this problem, research is underway into the creation of face models. Ekman et al. (Ekman P., Friesen W. V. “Facial Action Coding System,” Consulting Psychologist Press. 1997.) define a protocol known as FACS (Facial Action Coding System) that groups the movements of the facial muscles that appear on the surface of the face into 44 basic units (Action Units, hereinafter, AU).

Based on these, Morishima (Shigeo Morishima and Yasushi Yagi “Standard Tools for Facial Recognition/Synthesis,” System/Control/Information, Vol. 44, No. 3, pp. 119-26. 2000-3.) used the FACS described above to select 17 AUs that were sufficient for expression of facial expression movements, and synthesized facial expressions by quantitative combinations thereof.

As the AUs are defined on a pre-existing standard model that was prepared beforehand, when an expression is synthesized for an arbitrary face model, it is necessary to fit the standard model to the individual synthesis target, which may result in a loss of expressiveness.

For example, as it is difficult to produce an expression using this technique for representations of wrinkles, there was a demand for further technical development; there is also a need for tools for producing expressions and animations.

Meanwhile, a system is being researched wherein identity mapping training is used for an identity mapping layer neural network, which is a five-layer neural network; an emotional space is postulated wherein 17-dimensional expression synthesis parameters are compressed into three dimensions in the middle layer, and at the same time, expressions are mapped to this space and reverse mapped (emotional space−>expression), whereby emotion analysis/synthesis is performed. (Kawakami, Sakaguchi, Morishima, Yamada, and Harashima, “An Engineering-Psychological Approach to Three-Dimensional Emotional Space Based on Expression,” Technical Report of the Institute of Electronics, Information and Communication Engineers HC93-94. 1994-2003.)

Furthermore, research is underway into bidirectional conversion of trajectories in emotional space and changes in expression using a multilayer neural network (Nobuo Kamishima, Shigeo Morishima, Hiroshi Yamada, and Hiroshi Harashima, “Construction of an Expression Analysis/Synthesis System Based on Emotional Space Comprising a Neural Network,” Journal of the Institute of Information and Communication Engineers, D-II, No. 3, pp. 537-82. 1994.), (Tatsumi Sakaguchi, Hiroshi Yamada, and Shigeo Morishima, “Construction and Evaluation of a Three-Dimensional Emotional Model Based on Facial Images,” Journal of the Institute of Electronics, Information and Communication Engineers A Vol. J80-A, No. 8, pp.1279-84. 1997.).

Here, as described above, while research is underway into the representation of emotional states in three-dimensional space, in the present invention, in a computer device provided with input means, recording means, control means, output means, and display means, n-dimensional expression synthesis parameters corresponding to basic emotions, based on the aforementioned AUs or AU combinations, are used as base data; and expression synthesis parameters for each basic emotion are used as neural network training data so as to construct a three-dimensional emotional space and acquire emotional curves (curves in emotional space having as parameters the strength of basic emotions).

To produce an expression, coordinates are found in three-dimensional emotional space based on a blend of emotions; n-dimensional expression synthesis parameters are restored, and using a program for producing 3D computer graphics, a model expression is produced by combining these with shape data (difference data for a deformation model corresponding to data for an expressionless model). Furthermore, in order to vary expression along a time axis, expression synthesis parameters, corresponding to desired blend ratios for basic emotions and intermediate emotions, are restored and combined with shape data, so as to produce a method of continuously producing facial expressions, whereby the aforementioned problems were solved. By these means, it is possible to define basic movements for each piece of shape data to be combined (face model), allowing for highly expressive expression outputs, such as wrinkles.

As a result, expressions can be synthesized by intuitive emotional operations, more natural expression transitions can be represented, and it is possible to reduce the amount of data for animations.

Furthermore, in the system of the present invention, the process that determines the expression synthesis parameters based on emotional blends and the process that produces the expression in the model based on the expression synthesis parameters are independent of each other, allowing for use of existing expression synthesis engines, 3D computer graphics drawing libraries, model data based on existing data formats, and the like, allowing for technology-independent implementation of expression synthesis, such as by plug-in software for 3D computer graphics software, and the like, and for data exchange between various systems.

### DISCLOSURE OF THE INVENTION

In order to solve the aforementioned problems, the invention as recited in claim 1 is characterized in that,

this is a system for compressing n-dimensional expression synthesis parameters to emotion parameters in three-dimensional emotional space, which is provided in a computer device comprising input means, storage means, control means, output means, and display means, and which is used for producing 3D computer graphics expression models based on emotion, the system for compression to emotional parameters in three-dimensional emotional space being characterized in that,

said system comprises computation means for producing three-dimensional emotion parameters from n-dimensional expression synthesis parameters by identity mapping training of a five-layer neural network; and

the computations performed by said computation means are computational processes wherein, using a five-layer neural network having a three-unit middle layer, training is performed by applying the same expression synthesis parameters to the input layer and the output layer, and computational processes wherein expression synthesis parameters are input to an input layer of the trained neural network, and compressed three-dimensional emotional parameters are output from the middle layer.

Furthermore, in order to solve the aforementioned problems, the invention as recited in claim 2 is characterized in that,

this is a system for compression to emotional parameters in three-dimensional emotional space characterized in that, in the invention as recited in claim 1,

data used in neural network training are expression synthesis parameters for expressions corresponding to basic emotions.

Furthermore, in order to solve the aforementioned problems, the invention as recited in claim 3 is characterized in that,

this is a system for compression to emotional parameters in three-dimensional emotional space characterized in that, in the invention as recited in claim 1,

data used in neural network training are expression synthesis parameters for expressions corresponding to basic emotions and expression synthesis parameters for intermediate emotions between these expressions.

Furthermore, in order to solve the aforementioned problems, the invention as recited in claim 4 is characterized in that,

this is a system for formation of a 3D computer graphics expression model based on emotion, the system being for forming a 3D computer graphics expression model based on emotional transition, and provided in a computer device comprising input means, storage means, control means, output means, and display means, characterized in that this comprises:

storage means for storing the last three layers of a five-layer neural network for expanding three-dimensional emotion parameters into n-dimensional expression synthesis parameters, three-dimensional emotion parameters in emotional space corresponding to basic emotions, and shape data that serves as a source for the formation of a 3D computer graphics expression model for expression synthesis; means for deriving emotion parameters in emotional space corresponding to specific emotions; and

calculation means whereby, using data for the last three layers in a five-layer neural network having a three-unit middle layer, emotion parameters, which were derived by the emotional parameter derivation means, are input to the middle layer, and expression synthesis parameters are output at the output layer.

Furthermore, in order to solve the aforementioned problems, the invention as recited in claim 5 is characterized in that,

this is the system for formation of a 3D computer graphics expression model based on emotion as recited in claim 4, characterized in that, in the invention as recited in claim 4,

said emotion parameter derivation means are such that, blend ratios for basic emotions are input by said input means, a three-dimensional emotion parameter in emotional space corresponding to a basic emotion is referenced in initial storage means, and an emotion parameter corresponding a blend ratio is derived.

Furthermore, in order to solve the aforementioned problems, the invention as recited in claim 6 is characterized in that,

the system for formation of a 3D computer graphics expression model based on emotion as recited in claim 4, characterized in that, in the invention as recited in claim 4,

said emotional parameter derivation means are means for deriving emotional parameters based on determining emotions by analyzing audio or images input by said input means.

Furthermore, in order to solve the aforementioned problems, the invention as recited in claim 7 is characterized in that,

the system for formation of a 3D computer graphics expression model based on emotion as recited in claim 4, characterized in that, in the invention as recited in claim 4,

said emotional parameter derivation means are means for generating emotional parameters by computational processing on the part of a program installed in said computer device.

### BRIEF DESCRIPTION OF THE DRAWINGS

FIG. 1 is a drawing illustrating the basic hardware structure of a computer device used in the system of the present invention.

FIG. 2 is a block diagram illustrating the processing functions of a program implementing the functions of the system of the present invention.

FIG. 3 is a drawing illustrating one example of a model with varied expressions based on the 17 AUs.

FIG. 4 is a table showing an overview of the 17 AUs.

FIG. 5 is a table showing the blend ratios of the six basic emotions, based on combinations of AUs.

FIG. 6 is a system structure diagram for the present invention.

FIG. 7 is a block diagram showing processing data flow in the present invention.

FIG. 8 is a table showing specifications for a neural network.

FIG. 9 is a structural diagram of a neural network.

FIG. 10 is a drawing illustrating the six basic emotions of anger, disgust, fear, happiness, sadness, and surprise.

FIG. 11 is a diagram showing emotional space generated in a middle layer as a result of identity mapping training and emotion curves in the emotional space.

FIG. 12 is a drawing illustrating one example of a model representing the operation of a movement unit, including difficult representations, such as wrinkles.

FIG. 13 is a drawing of one example of reproduction of an intermediate emotional expression according to blend ratios of basic expression models.

FIG. 14 is a drawing illustrating one example of the creation of a facial expression by combining basic expression models according to blend ratios.

FIG. 15 is a drawing illustrating one example of the results of creating an animation by outputting an expression corresponding to points in a constructed emotional space while moving from one basic emotion to another basic emotion.

FIG. 16 is a drawing illustrating one example of the results of creating an animation by outputting an expression corresponding to points in a constructed emotional space while moving from one basic emotion to another basic emotion.

FIG. 17 is a diagram illustrating a parametric curve described in emotional space for an animation.

FIG. 18 is a diagram illustrating the processing flow for one mode of embodiment of the present invention.

FIG. 19 is a diagram illustrating processing for emotional parameter derivation in one mode of embodiment of the present invention.

### BEST MODE FOR CARRYING OUT THE INVENTION

Hereinafter, the system of the present invention is described with reference to the drawings.

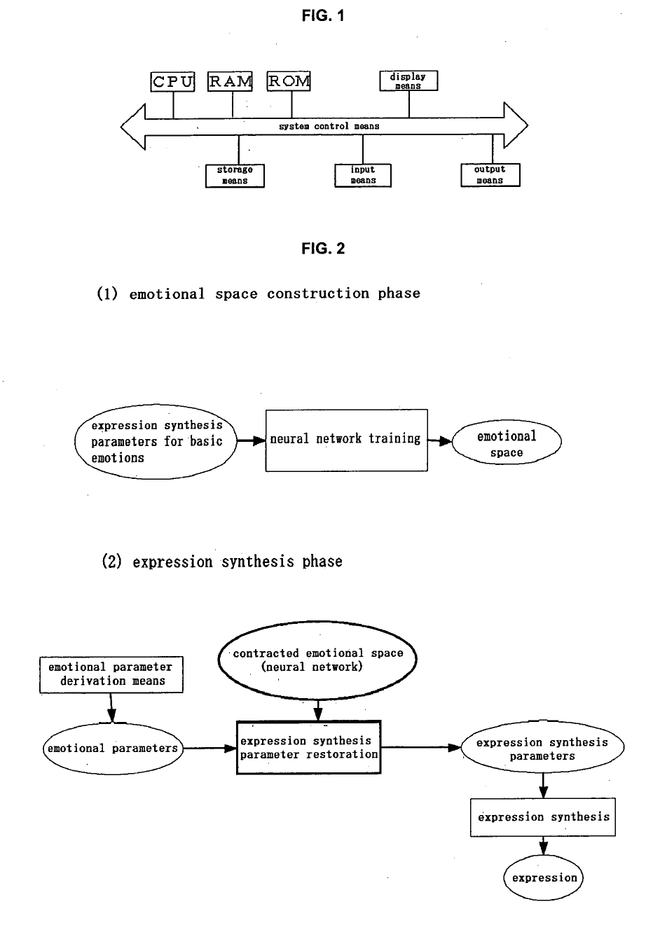

FIG. 1 is a drawing illustrating the basic hardware structure of a computer device used in the system of the present invention.

This has a CPU, a RAM, a ROM, system control means, and the like; it comprises input means for inputting data or inputting instructions for operations and the like, storage means for storing programs, data, and the like, display means for outputting displays, such as menu screens and data, and output means for outputting data.

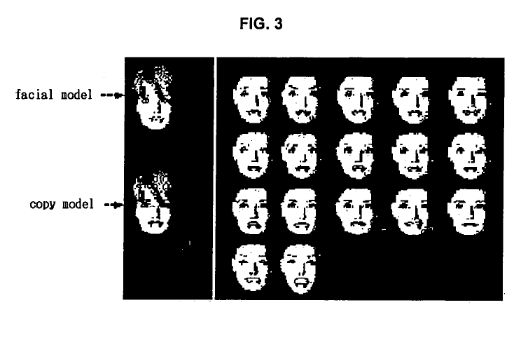

FIG. 2 is a block diagram illustrating the processing functions of a program that implements the functions of the system of the present invention; the program for implementing these functions is stored by the storage means, and the various functions are implemented by controlling the data that is stored by the storage means.

“(1) Emotional space creation phase,” as shown in FIG. 2, shows a process for construction of emotional space by training a neural network using expression synthesis parameters corresponding to basic emotions as the training data.

“(2) Expression synthesis phase,” shows a process wherein data for three-dimensional coordinates in emotional space is obtained by emotional parameter derivation, such as specifying blend ratios for basic emotions; expression synthesis parameters are restored using a neural network; these are used as shape synthesis ratios, and shape data is geometrically synthesized so as to produce an expression model.

The storage means store data for emotional curves corresponding to a series of basic emotions in an individual, which is to say parametric curves in three-dimensional emotional space, which take as parameters the strength of basic emotions.

Furthermore, data is stored for the last three layers of a five-layer neural network that serves to expand three-dimensional emotion parameters into n-dimensional expression synthesis parameters.

Furthermore, shape data is stored, which is the object of the 3D computer graphic model production.

Furthermore, these store an application program that produces the 3D graphics, an application program, such as plug-in software, for performing the computations of the system of the present invention, an operating system (OS), and the like.

Furthermore, the emotional parameter derivation means for setting the desired blend ratios for the various basic emotions in the emotional space are provided in the computer terminal.

The means for deriving emotion parameters are, for example, means which input blend ratios for the various basic emotions by way of the input means described below.

Input means include various input means, such as keyboards, mice, tablets, touch panels, and the like. Furthermore, for example, liquid crystal screens, CRT screens, and such display means, on which are displayed icons and input forms, such as those for basic emotion selection and those for the blend ratios described below, are preferred graphical user interfaces for input, as these facilitate user operations.

Furthermore, another mode for the emotional parameter derivation means is based on determining emotions by analyzing audio or images input by means of the input means described above.

Moreover, another mode for the emotional parameter derivation means is that wherein emotion parameters are generated by computational processing on the part of a program installed in the computer device.

Furthermore, the computer device is provided with computation means for: reading emotional curves from the storage means based on the desired blend ratios for basic emotions input by the input means and determining the emotion parameters in the emotional space in accordance with the blend ratios; reading the data for the last three layers of the five-layer neural network from the storage means and restoring the expression synthesis parameters; and reading shape data from the storage means in order to perform expression synthesis.

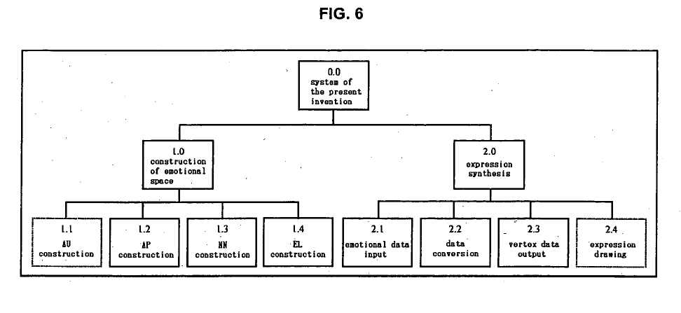

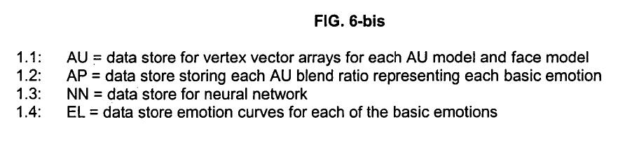

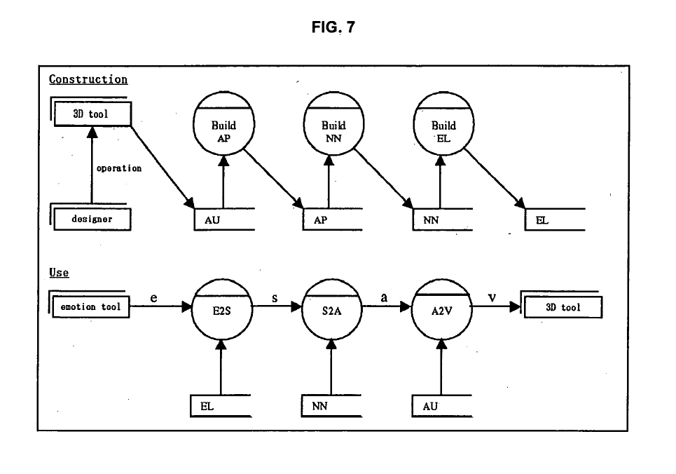

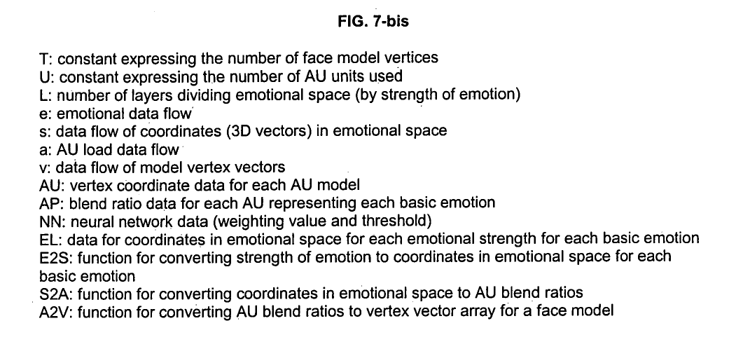

A structural diagram of the system of the present invention is shown in FIG. 6. Furthermore, FIG. 7 is a functional block diagram showing processing functions.

In FIG. 6, reference symbol AU indicates a data store for vertex vector arrays for a face model and for each AU model; reference symbol AP indicates a data store that stores the blend ratio for each AU, representing each basic emotion; reference symbol NN indicates a data store for a neural network; reference symbol EL indicates a data store that stores the intersections of each basic emotion and each layer in the emotional space; the data are stored in the storage means and are subject to computational processing by the computation means.

Next, FIG. 7 shows data flow in the present invention.

In FIG. 7, reference symbol T indicates a constant expressing the number of vertices in the face model; reference symbol U indicates a constant expressing the number of AU units used; reference symbol L indicates the number of layers that divide the emotional space into layers according to the strength of the emotion. Furthermore, reference symbol e indicates emotion data flow; reference symbol s indicates emotional space vector data flow; reference symbol a indicates AU blend ratio data flow; and reference symbol v indicates model vertex vector data flow. Furthermore, reference symbol EL indicates a data store which stores the intersections of the various basic emotions and the various layers in emotional space; reference symbol NN indicates a data store for a neural network; reference symbol AU indicates a data store for vertex vector arrays for various AU models and face models.

Reference symbol E2S indicates a function which converts the six basic emotional components into vectors in emotional space; reference symbol S2A indicates a function that converts vectors in emotional space to AU blend ratios; and reference symbol A2V indicates a function that converts AU blend ratios into face model vertex vector arrays. The functions are used in computations by the computation means.

Embodiment 1

First, we describe the emotional space construction phase in FIG. 2, which is to say a method of using neural network identity mapping training to construct a conversion module that restores n-dimensional expression synthesis parameters that were compressed into coordinates in emotional space and labeled three-dimensional space.

The invention recited in claim 1 is a system used for producing 3D computer graphics expression models based on emotion, which compresses n-dimensional expression synthesis parameters to emotion parameters in three-dimensional emotional space.

The system in the present mode of embodiment is provided with a computation means, which performs identity mapping training for a five-layer neural network.

The computations performed by the computation means use a five-layer neural network having a three-unit middle layer; the same expression synthesis parameters are applied to the input layer and the output layer, and training is performed by computational processing.

In order to synthesize a basic face model by means of computer graphics (hereinafter, CG), shape data is defined beforehand for individually defined basic facial expression actions (for example, raising of eyebrows or lowering of the corners of the mouth), and an expression model is created which corresponds to a basic emotion by way of blend ratios thereof.

For each piece of shape data, the blend ratios for the corresponding expression are used as expression synthesis parameters; these allow the construction of emotional space that represents facially expressed emotional states in three-dimensional space, using the identity mapping capacity of a neural network.

Note that, in the present specification, all “expression spaces wherein emotional states expressed on a human face are spatially represented” are hereinafter referred to as “emotional spaces.”

The FACS (Facial Action Coding System) can be used as a method for describing human expressions. FACS describes 44 anatomically independent changes in the human face (Action Units, hereinafter AUs) by way of qualitative/quantitative combinations.

Expressions for what Ekman et al. refer to as the six basic emotions (anger, disgust, fear, happiness, sadness, and surprise) can be described by carefully selecting somewhat more than 10 AUs.

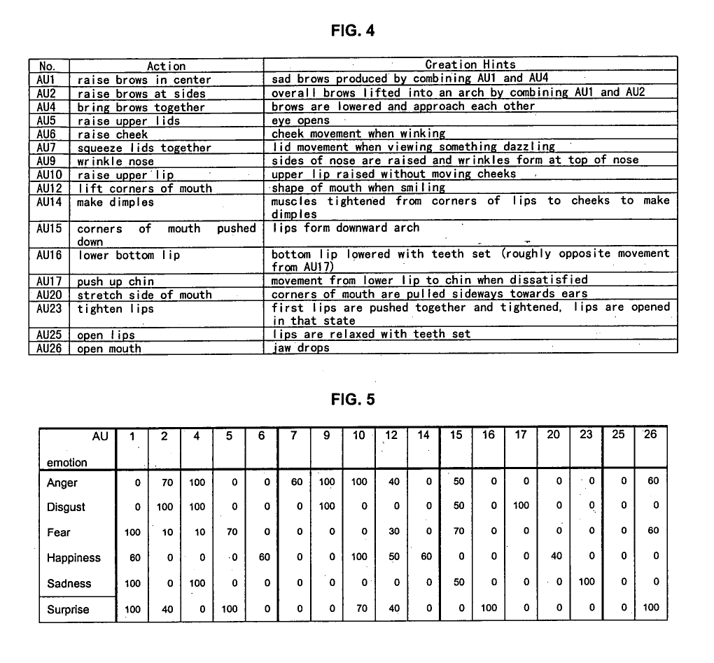

FIG. 4 shows an overview of 17 AUs; FIG. 3 shows one example of a model in which expression is varied based on the 17 AUs; furthermore, FIG. 5 shows an example of blending ratios for the six basic emotions according to combinations of the AUs.

Using the protocol known as FACS (Facial Action Coding System), the basic expression actions (Action Units, hereinafter AUs) are defined, and facial expressions are synthesized as combinations of AUs. As AUs are defined on standard existing models that are prepared beforehand, when expressions are synthesized with an arbitrary face model, it is necessary to fit this standard model to the individual object of synthesis, which may result in a loss of expressiveness. For example, for representation of wrinkles, it is difficult to achieve a representation with this technique; using the present technique, it is possible to define basic actions for each face model to be combined, allowing for highly expressive expression outputs, such as wrinkles.

In terms of a method of describing specific blend ratios, for example, in the case of an expression of anger, AU weighting values are combined as in, AU2=0.7, AU4=0.9, AU8=0.5, AU9=1.0, and AU1 5=0.6, or the like. By combining according to these ratios, a facial expression can be produced (FIGS. 1, 4).

A plurality of basic faces, such as “upper lids raised” or “both ends of the mouth pulled upwards,” are produced separately, and these are combined according to blend ratios. By varying the blend ratios, it is possible to produce various expressions, such as the six basic expressions.

Models representing the actions for each movement unit are created separately, and complex representations, such as wrinkles and the like, can be produced (FIGS. 1, 2).

In the invention as recited in claim 2, data used in neural network training are expression synthesis parameters for expressions corresponding to basic emotions; expressions based on the basic emotions are the six basic emotions of anger, disgust, fear, happiness, sadness, and surprise in FIGS. 1, 0, or the like; in terms of the training method, the expression synthesis parameters for the six basic emotions (anger, disgust, fear, happiness, sadness, and surprise) are used as the training data for the input and the output.

FIGS. 1, 4 shows an example of producing an expression corresponding to the basic emotion of fear by blending the basic expressions A, B, and C.

Furthermore, in the invention as recited in claim 3, data used in neural network training are expression synthesis parameters for expressions corresponding to basic emotions and expression synthesis parameters for intermediate emotions between these expressions; examples of expressions of intermediate emotions between these basic emotions are shown in FIGS. 1, 3; these are reproduced by way of blend ratios for basic expression models.

In terms of the training method, expression synthesis parameters for the six basic emotions (anger, disgust, fear, happiness, sadness, and surprise) are used as the training data for the input and the output; in the present mode of embodiment, intermediate expressions for these expressions are used as learning data to realize an ideal generalization capacity.

A plurality of basic faces, such as “upper lids raised” or “both end of mouth pulled upwards,” are produced separately, and these are combined according to blend ratios. By varying the blend ratios, it is possible to produce various expressions, such as the six basic expressions.

Next, the bidirectional conversion of changes in expressions and trajectories in emotional space will be described.

Expressions and emotions can be bidirectionally converted using a multilayer neural network.

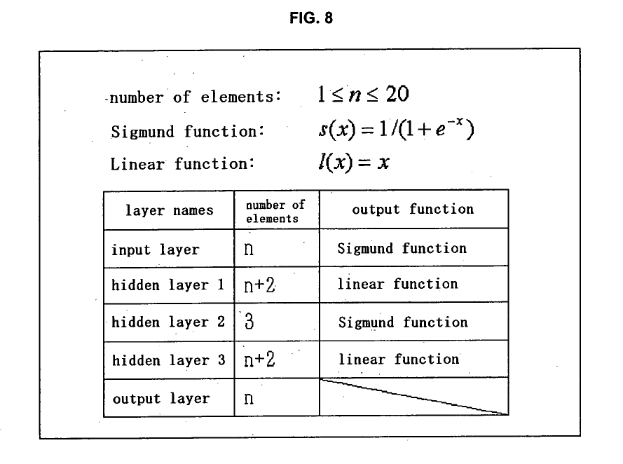

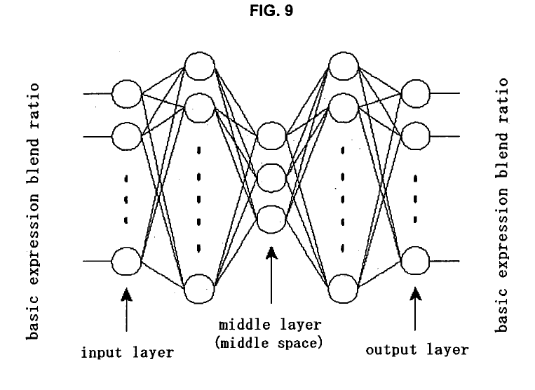

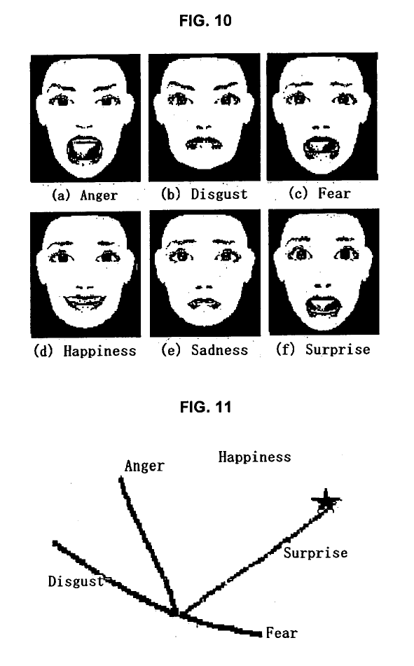

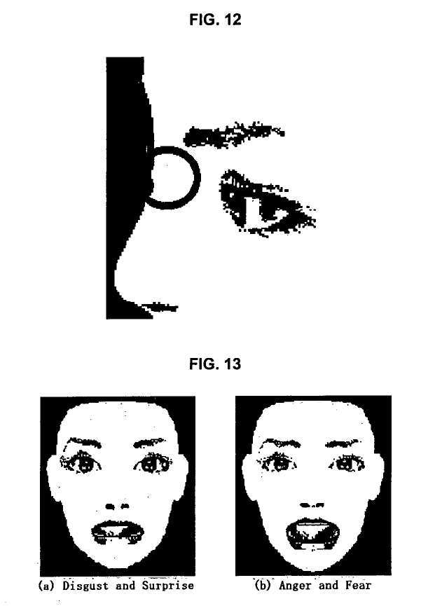

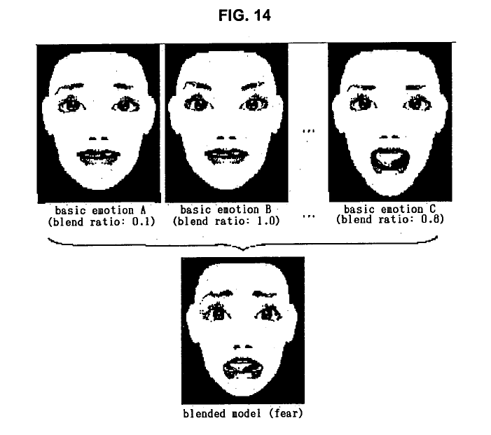

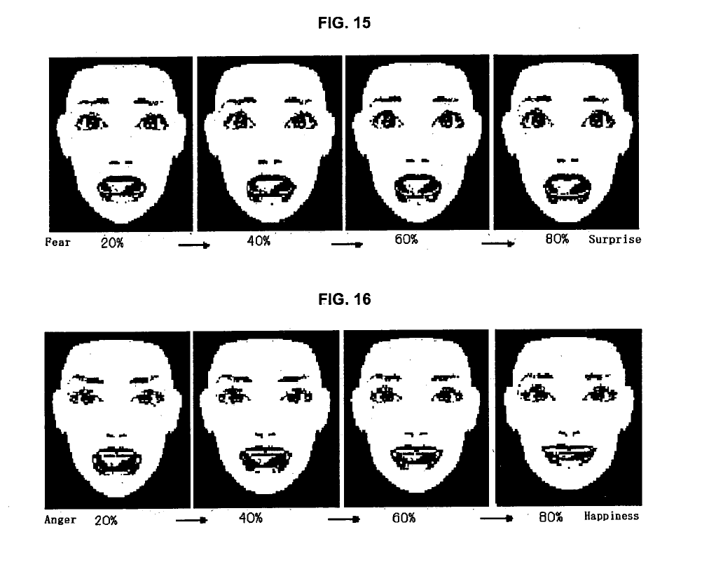

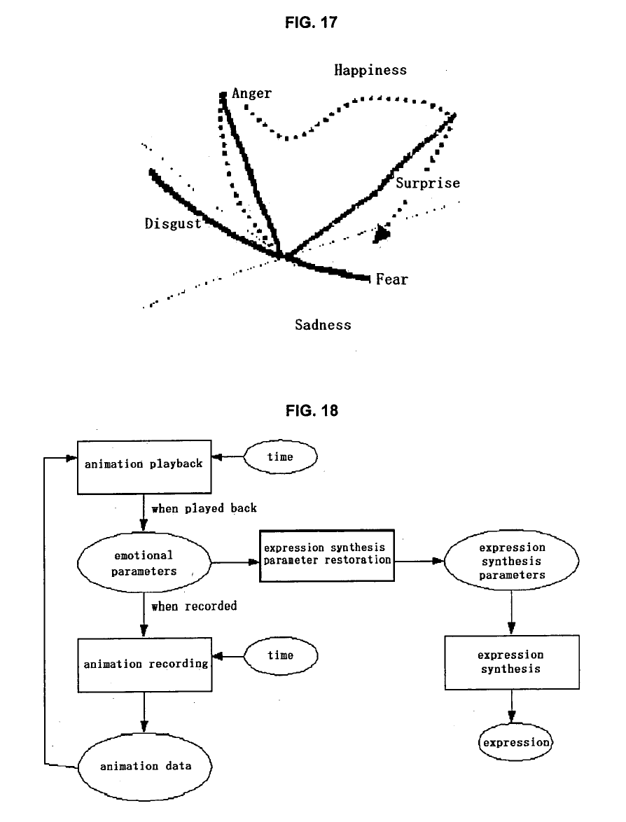

The structure of the neural network is shown in FIG. 8 and FIG. 9.

Weighting values are given to the AUs corresponding to the six basic emotions as the input signal and the instruction signal, and these are converged by the error back-propagation method (identity mapping training).

The advantages of the error back-propagation training method are that, simply by successively providing sets of input signals and the correct output instruction signals, an internal structure that extracts characteristics of individual problems self-organizes as synaptic connections of hidden neuron groups in the middle layers. Furthermore, error computation is very similar to forward information flow. In other words, only information produced from following elements is used for training of an element, so as to maintain training localization.

In the five-layer hourglass-type neural network having a three-unit middle layer shown in FIG. 9, blend ratios for basic faces are applied to the input and output layers, identity mapping training is performed, and the three-dimensional output of the middle layer is taken as emotional space. A system is created wherein expression analysis expression analysis/synthesis is performed by mapping the three layers, from the input to the middle layer, to emotional space from blend ratios, and reverse mapping the three layers from the middle layer to the output.

The method of constructing three-dimensional emotional space mentioned above also uses identity mapping. Identity mapping ability is as illustrated below. In a five-layer neural network, such as in FIG. 9, if learning is performed by applying the same patterns to the input layer and the output layer, a model is constructed in which the pattern that was input is output without modification. At this point, in the middle layer, where the number of units is smaller than in the input and output layers, the input pattern is compressed so as to conserve the input characteristics; these characteristics are reproduced and output at the output layer.

If training is performed with blending ratios for basic expression models applied to the input and output layers, the characteristics are extracted from the blend ratios of the basic expression models in the middle layer, and these are compressed to three dimensions. If this is taken as emotional space, it is possible to capture information on an emotional state from the blend ratios of the basic expressions.

At this time, the learned data reproduces the six basic emotions of anger, disgust, fear, happiness, sadness, and surprise (FIGS. 1, 0) and the expressions for the intermediate emotions thereof (FIGS. 1, 3) according to the blend ratios of the basic expression models. The blend ratios are expressed as 0.0-1.0, but as the neural network uses a Sigmund function that converges on 1.0 and −1.0, there is a risk of output values decreasing with inputs near 1.0. Thus, when the blend ratios are used as training data, these are standardized at values between 0.0 and 0.8.

The training procedure is illustrated below.

1) Training is performed with training data wherein, for all of the six basic expressions/intermediate expressions, the degrees of emotion are 0% and 25%.

2) If the training error is, for example, less than 3.0×10e−3, 50% emotion is added for the first time, and training is continued with training data of 0%, 25%, and 50%.

3) Training data is increased to 75% and 100% in the same manner.

Furthermore, the increases in training data may be 10% increment increases, such as 10%, 20%, 30%, 40%, 50%; and training may be performed using other arbitrary percentages.

This is so that strong identity mapping capacity can be achieved for each emotion.

As a result of performing identity mapping training in this manner, after the training terminates and the emotional space has been constructed, it is possible to produce three-dimensional data, which is to say coordinates in emotional space, corresponding to the blend ratio data, from the middle layer; when AU blend ratio data is applied to the input layer, the emotional space generated in the middle layer is that in FIGS. 1, 1.

A trajectory for a basic emotion in the figure is such that the outputs produced from the three units in the middle layer, when blend ratios for each emotion from 1% to 100% are applied to the input layer of the neural network, are plotted in three-dimensional space as (x, y, z).

Embodiment 2

Next, the expression synthesis phase in FIG. 2, which is to say, the process of obtaining the three-dimensional coordinate data in emotional space by such emotional parameter derivation as specifying blend ratios for basic emotions, restoring the expression synthesis parameters using a neural network, and producing an expression model by taking these as blend ratios and geometrically blending shape data, will be explained.

In FIG. 9, coordinates in emotional space are applied to the middle layer, and AU weighting values can be restored from the output layer.

The invention recited in claim 4 is a 3D computer graphics expression model formation system provided in a computer device provided with an input means, a storage means, a control means, an output means, and a display means, wherein expressions are synthesized based on emotional transitions.

Provided are: storage means for storing the last three layers of a five-layer neural network for expanding three-dimensional emotion parameters into n-dimensional expression synthesis parameters, three-dimensional emotion parameters in emotional space corresponding to basic emotions, and shape data that serves as a source for the formation of a 3D computer graphics expression model for expression synthesis; means for deriving emotion parameters in emotional space corresponding to specific emotions; and calculation means whereby, using data for the last three layers in a five-layer neural network having a three-unit middle layer, emotion parameters, which were derived by the emotional parameter derivation means, are input to the middle layer, and expression synthesis parameters are output at the output layer.

First, a computer device provided with an input means, a storage means, a control means, an output means, and a display means, is used, and the basic emotion blend ratios are set using the emotional parameter derivation means.

The process of setting the blend ratios is, as one example of a preferred mode, as recited in claim 5, a process wherein the blend ratios for each of the basic emotions are input by way of the input means, the three-dimensional emotion parameters in emotional space corresponding to the basic emotions are referenced in the storage means, and the emotion parameters corresponding to the blend ratios are derived.

For example, a blend ratio is specified as “20% fear, 40% surprise.”

Furthermore, as recited in claim 9, if data is used that was learned by applying expression synthesis parameters for expressions corresponding to basic emotions and expression synthesis parameters for intermediate expressions between these expressions, basic emotion and intermediate emotion blend ratios can be specified.

Next, based on the blend ratios which were set using the emotional parameter derivation means, emotion parameters can be obtained, which are three-dimensional coordinate data in emotional space.

In the expression synthesis data flow diagram in FIG. 7, processing is such that emotional data is output by means of calculating emotional space vector data using a function (E2S) that converts the six basic emotional components to vectors in emotional space.

Next, using data for the last three layers in a five-layer neural network having a three-unit middle layer, emotion parameters, which were derived by the emotional parameter derivation means, are input to the middle layer, and expression synthesis parameters are output at the output layer.

FIG. 2 shows the process of restoration of expression synthesis parameters; the compressed three-dimensional data is expanded to n-dimensional expression synthesis parameters, which is to say, data indicating AU blend ratios. Furthermore, in the expression synthesis data flow diagram in FIG. 7, the processing is such that AU blend ratio data is output by means of computation using a function that converts data for vectors in emotional space to AU blend ratios.

FIG. 5 shows the 17 AU blend ratios that constitute the six basic emotions; but the computation means process emotion, such as, in terms of the previous example, “20% fear, 40% surprise,” so as to expand this to data that indicates AU blend ratios.

Next, in the expression synthesis data flow diagram in FIG. 7, the restored expression synthesis parameters, and specifically, the data that indicates AU blend ratios, is output as vertex vector data for shape data, using a function that converts it to an array of vertex vectors for shape data (face model), whereby a model expression is produced.

The invention recited in claim 10 is a system for forming expressions by using n-dimensional expression synthesis parameters expanded from three-dimensional emotion parameters as blend ratios for the shape data, which is the object of 3D computer graphic expression model formation, so as to blend shape data geometrically.

By the above means, it is possible to form an expression on the target shape data by specifying emotion blend ratios.

Furthermore, in another mode of embodiment of the present invention, as in the invention recited in claim 11, the shape data that is the source for the geometrical blend can be processed as data previously recorded by the storage means as local facial deformations (AU based on FACS, and the like), independent of emotions. For local facial deformations, the processing is such that expressions are formed, based on emotion, in facial site units, such as “furrowing the brows” or “making dimples,” such as shown by the AUs in FIG. 4.

Embodiment 3

Next, a process of forming an animation by varying the expression of a target model according to variations in emotion, as recited in claim 13, will be described.

The present mode of embodiment is characterized in that temporal transitions in expressions are described as parametric curves in emotional space, using the emotion parameters set by the emotional parameter derivation means and emotion parameters after a predetermined period of time; expression synthesis parameters are developed from points on the curve at each time (=emotional parameter), and the developed parameters are used, allowing for variation of expressions by geometrically blending shape data.

Animations are created by outputting an expression corresponding to points in constructed emotional space while moving from one basic emotion to another basic motion; the results of examples thereof are given in FIGS. 1, 5 and FIGS. 1, 6.

Regardless of the descriptive method used by the 3D computer graphics (polygon, mash, NURBS, etc.), model shapes are determined by vertex vectors. The vertex vectors of the model may be moved according to time in order to perform deformation operations on the 3D computer graphics model. As shown in FIGS. 1, 7, it is possible to describe an animation as a parametric curve in emotional space.

This can greatly reduce data volume for long-duration animations.

In order to vary the expression of a given model, first the following preparation is done.

First, the mobile vectors corresponding to vertex coordinates are determined for each AU.

Next, the AU blend ratio data is determined for each basic emotion.

Next, training is performed on the neural network.

Next, the coordinates in emotional space corresponding to expressionlessness are found.

Next, the coordinates in emotional space for each basic emotion are found.

When the preparation is complete, the following expression variations are possible.

First, the AU blend ratio data is found from the coordinates in emotional space.

Next, for each AU, the product of the blend ratio data and the relative mobile vector is found.

Next, the above product is combined and added to the vertex vector of the model, so as to produce an expression in the model corresponding to the coordinates in emotional space.

Next, the position is moved through time (coordinate in emotional space−>model vertex vector).

Here, the specific method for calculating the vertex coordinates is as follows.

For example, in order to produce an expression operation wherein, in the model, at a time

t₁

anger is 80%, and at

t₂

happiness is 50%, for time

t:t₁≦t≦t₂

a model vertex coordinate can be found as

\vec{v}ᵢ:0≦i<T

This method is as follows.

The coordinate in emotional space can be found by linear interpolation over time:

\vec{e}ₜ=\vec{e}₀+0.8(\vec{e}ₜ_{₀}−\vec{e}₀)(t₂−t)/(t₂−t₁)+0.5(\vec{e}ₜ_{₁}−\vec{e}₀)(t−t₁)/(t₂−t₁)

the coordinate in emotional space is converted to AU blend ratio data:

\vec{w}ₜ=ƒ(\vec{e}ₜ)

and the various model vertex coordinates are found from the AU blend ratio data.

\vec{v}ᵢ(t)=\vec{v}ᵢ+AUᵢ·\vec{w}ₜ

FIGS. 1, 8 illustrates the processing flow in the present mode of embodiment.

Animation data can be produced by recording emotion parameters with times.

When the animation is to be reproduced, the emotion parameters are extracted from the recorded animation data at specific times, and this is applied to the input of the expression synthesis parameter restoration.

As described in detail above, in the 3D computer graphics model formation system of the present invention, a target model can be varied according to blends of six basic emotions, and an animation can be produced by varying these along a time axis; the following mode can be added as a processing procedure.

For example, as a method of forming a model by manual operation, a model can be constructed with the following procedure on an expression animation target model.

Various deformation models are produced by manual operations, according to the indications for each AU (see FIG. 4); next, the blend ratios for AUs that represent the six basic emotions are manually adjusted.

Next, neural network training, conversions, and generation of emotional space are performed.

Next, expression actions are quantitatively reproduced based on the AUs of the 3D model, according to the movement of the coordinates in emotional space.

As a method of forming a model by automatic generation, a model can be constructed with the following procedure on a target expression animation model.

By mapping a previously prepared template model (vertex movement rates are already set for each AU) and the object model, each AU deformation model is automatically generated from the object model.

Next, expressions are output that represent the six basic emotions according to the previously set AU blend ratios and, if necessary, adjusted manually.

In the following, an expression animation is produced by the same procedure as in the manual production version.

Embodiment 4

As a further mode of embodiment of the present invention, further development is possible by combining an emotion estimating tool.

Trajectories can easily be generated in emotional space based on the output of a tool that measures human emotion. The following is an example of inputs for measuring human emotion.

Expression (image input terminal, real-time measurement, and measurement from recorded video).

Audio (audio input terminal, real-time or recorded audio, the object can also be singing).

Body movement (head, shoulders, arms, and the like, changes in keyboard typing style, and the like are possible).

Emotion can be measured with these individually or in combinations, and these can be used as input data (“E2S” in FIG. 7 is a function for converting emotional data to emotional space).

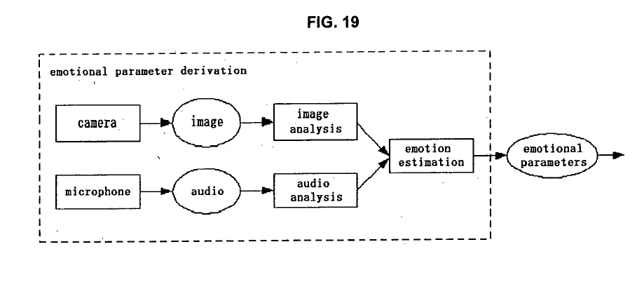

FIG. 19 illustrates processing for emotional parameter derivation in one mode of embodiment of the present invention; a real-time virtual character expression animation emotional parameter derivation module, using recognition technology, serves as an emotion estimation module that recognizes audio using a microphone and analyzes images using a camera. The expression synthesis module is a program that uses a 3D drawing library and is capable of real-time drawing.

For example, in the invention recited in claim 6, means are used as the emotional parameter derivation means, which derive emotion parameters based on emotion determined by analysis of audio or images input by the input means.

By recording values that indicate the basic emotions as combinations of such elements as voice intonation, voice loudness, accent, talking speed, voice frequency, and the like, and by registering these values beforehand, preferably for a particular individual, the blend ratios of basic emotions are derived, and coordinates in three-dimensional emotional space are found by analyzing audio input from an input means, such as a microphone.

Furthermore, if this data, a program to process data, and shape data, such as one's own face or a character's face, are stored in the computer terminal of each user, it is possible to construct a system whereby expressions corresponding to emotions can be transmitted and received by the various forms of communication described below.

Embodiment 5

Furthermore, in the invention recited in claim 7, means that derive emotion parameters based on emotion found by way of computational processing by a program installed on the computer device are used as the emotional parameter derivation means.

For example, in a game program, values which indicate emotions and correspond to values, such as the scores of game contestants and elements, such as events, actions, and operations in the game, are established and stored, so that basic emotion blend ratios and the like are derived in response to emotions corresponding to values, such as the scores of game contestants and elements, such as events, actions, and operations in the game, and coordinates in three-dimensional emotional space are determined.

By controlling the emotion parameters, a character expression animation playback program can generate emotion parameters directly from internal data. In games and the like, it is possible to represent character expressions that vary in response to situations by calculating emotion parameters from current internal states.

In the present mode of embodiment, by storing this data, a program to process this data, and shape data, such as one's own face or a character's face, on the computer terminal of each user, it is possible to construct a system whereby expressions corresponding to emotions can be transmitted and received by the various forms of communication described below.

This is, for example, a network communication system using a virtual character; each terminal has an emotional parameter derivation module using recognition technology, and the derived emotion parameters are sent to the other communication party over the network. On the receiving side, the emotion parameters which have been sent are used for expression synthesis, and the expressions synthesized are drawn on a display device.

When communications are established, emotional space (=trained neural network) and shape data used in expression synthesis are exchanged, whereby only emotional parameter data is transmitted and received in real-time, which reduces communication traffic.

Next, by using various types of input and output terminals, various different modes of embodiment are possible, depending on the information processing capacity of the playback terminal for the target model created and the data transfer capacity of the network.

An operator can add expressions to a target model on a device, such as a personal computer, a home game console, a professional game console, a multi-media kiosk terminal, an Internet TV, or the like using a program for carrying out the present invention, data for coordinates in emotional space for a basic face model, which is a basic face wherein a plurality of animation unit parameters that reproduce basic movements, such as a series of movements or expressions for an individual, are synthesized based on predetermined blend ratios, and coordinate data for the target model that is the object of 3D computer graphics model formation.

Note that, in addition to a mode wherein these are provided by storing them on the terminal device of an operator, the program and data described above may be provided on a storage device connected by way of the Internet, or the like, for example, in application service provider (ASP) format, so that these can be used while connected.

Examples of fields of application include, for example, in the case of one-to-one communication, e-mail with appended emotions, and combat games.

Examples include, in the case of (mono-directional) one-to-many communication, news distribution, in the case of (bidirectional) one-to-many communication, Internet shopping and the like, and in the case of many-to-many communication, network games and the like.

In addition, it is possible to provide a proprietary service in the form of communication means, such as cellular telephones (one-to-one) or remote karaoke machines (one-to-many), wherein emotions are input by way of audio, and which output expressions by way of (liquid crystal) screens.

### INDUSTRIAL APPLICABILITY

As described in detail above, the present invention provides a system whereby, by indicating the blend ratios for emotions, it is possible to produce expressions in target 3D computer graphics models, and which serves to bring about changes in expressions along a time axis.

Consequently, it is possible to create various expressions based on emotion. Furthermore, these expressions include wrinkles and the like, which are built into the basic expression model, allowing complex expressions.

When training with basic face blend ratios for the six basic emotions, it is possible to increase the generalization capacity of the neural network by training with gradually increasing degrees of expression, such as 0%, 25%, 50%, 75%, and 100%.

Furthermore, it is possible to achieve stronger identity mapping capacity and more generalization capacity by further training for various intermediate expressions of emotion, which cannot be classified according to the basic face and the six basic emotions.

Furthermore, by creating a plurality of individual basic faces, which express the basic facial actions, and synthesizing these according to blend ratios, it is possible to create more natural facial expressions. Furthermore, in neural network identity mapping training, it is possible to construct an emotional space having a more ideal generalization capacity by training for various intermediate emotional expressions that cannot be classified according to the six basic emotions alone.

Animations are created by outputting expressions corresponding to points in a constructed emotional space while moving from one basic emotion to another basic emotion; in resulting animations of movements from one basic emotional expression to another basic emotional expression, interpolation is performed for intermediate expressions between these expressions, which allows an ideal generalization capacity.

By constructing basic expressions for each model for each movement unit of the facial surface, it is possible to achieve complex representations, such as wrinkles. Furthermore, in identity mapping training, it is possible to construct an emotional space having a more ideal generalization capacity by applying, not only the six basic emotional expressions, but also the intermediate emotional expressions, as training data.

Furthermore, animations wherein expressions are varied with the passage of time can be described as parametric curves having time as a parameter in the constructed emotional space, whereby the animation data volume can be greatly reduced.

1. A system for compressing n-dimensional expression synthesis parameters to emotion parameters in three-dimensional emotional space, which is provided in a computer device comprising input means, storage means, control means, output means, and display means, and which is used for producing 3D computer graphics expression models based on emotion, the system for compression to emotional parameters in three-dimensional emotional space being characterized in that,
said system comprises computation means for producing three-dimensional emotion parameters from n-dimensional expression synthesis parameters by identity mapping training of a five-layer neural network; and
the computations performed by said computation means are computational processes wherein, using a five-layer neural network having a three-unit middle layer, training is performed by applying the same expression synthesis parameters to the input layer and the output layer, and computational processes wherein expression synthesis parameters are input to an input layer of the trained neural network, and compressed three-dimensional emotional parameters are output from the middle layer.

2. A system for compression to emotional parameters in three-dimensional emotional space characterized in that, in the invention as recited in claim 1,
data used in neural network training are expression synthesis parameters for expressions corresponding to basic emotions.

3. A system for compression to emotional parameters in three-dimensional emotional space characterized in that, in the invention as recited in claim 1,
data used in neural network training are expression synthesis parameters for expressions corresponding to basic emotions and expression synthesis parameters for intermediate emotions between these expressions.

4. A system for formation of a 3D computer graphics expression model based on emotion, the system being for forming a 3D computer graphics expression model based on emotional transition, and provided in a computer device comprising input means, storage means, control means, output means, and display means, characterized in that this comprises:
storage means for storing the last three layers of a five-layer neural network for expanding three-dimensional emotion parameters into n-dimensional expression synthesis parameters, three-dimensional emotion parameters in emotional space corresponding to basic emotions, and shape data that serves as a source for the formation of a 3D computer graphics expression model for expression synthesis; means for deriving emotion parameters in emotional space corresponding to specific emotions; and
calculation means whereby, using data for the last three layers in a five-layer neural network having a three-unit middle layer, emotion parameters, which were derived by the emotional parameter derivation means, are input to the middle layer, and expression synthesis parameters are output at the output layer.

5. The system for formation of a 3D computer graphics expression model based on emotion as recited in claim 4, characterized in that, in the invention as recited in claim 4,
said emotion parameter derivation means are such that, blend ratios for basic emotions are input by said input means, a three-dimensional emotion parameter in emotional space corresponding to a basic emotion is referenced in initial storage means, and an emotion parameter corresponding a blend ratio is derived.

6. The system for formation of a 3D computer graphics expression model based on emotion as recited in claim 4, characterized in that, in the invention as recited in claim 4,
said emotional parameter derivation means are means for deriving emotional parameters based on determining emotions by analyzing audio or images input by said input means.

7. The system for formation of a 3D computer graphics expression model based on emotion as recited in claim 4, characterized in that, in the invention as recited in claim 4,
said emotional parameter derivation means are means for generating emotional parameters by computational processing on the part of a program installed in said computer device.

8. The system for formation of a 3D computer graphics expression model based on emotion as recited in claim 4-7, characterized in that, in the invention as recited in claim 4-7,
the five-layer neural network that serves to expand three-dimensional emotional parameters into n-dimensional expression synthesis parameters was trained by applying expression synthesis parameters for expressions corresponding to basic emotions.

9. The system for formation of a 3D computer graphics expression model based on emotion as recited in claim 4-7, characterized in that, in the invention as recited in claim 4-7,
the five-layer neural network that serves to expand three-dimensional emotional parameters into n-dimensional expression synthesis parameters was trained by applying expression synthesis parameters for expressions corresponding to basic emotions and expression synthesis parameters for intermediate expressions between these expressions.

10. The system for formation of a 3D computer graphics expression model based on emotion as recited in claim 4-9, characterized in that, in the invention as recited in claim 4-9,
n-dimensional expression synthesis parameters expanded from three-dimensional emotional parameters are used as blend ratios for shape data, which is the object of 3-D computer graphic expression model formation, so as to produce an expression by blending shape data geometrically.

11. The system for formation of a 3D computer graphics expression model based on emotion as recited in claim 10, characterized in that, in the invention as recited in claim 10,
the shape data that is the source for the geometrical blending is data previously stored by said storage means as local facial deformations (AU based on FACS, and the like), independent of emotions.

12. The system for formation of a 3D computer graphics expression model based on emotion as recited in claim 11, characterized in that, in the invention recited in claim 11,
a facial model serving as a template and a facial model wherein this is locally deformed are prepared in advance, mapping of the facial model serving as a template and a facial model which is the object of expression forming is performed, whereby the facial model which is the object of expression forming is automatically deformed, creating shape data serving as the source for geometrical blending.

13. The system for formation of a 3D computer graphics expression model based on emotion as recited in claim 10-12, characterized in that, in the invention as recited in claim 10-12,
temporal transitions in expressions are described as parametric curves in emotional space, using emotional parameters set by said emotional parameter derivation means and emotional parameters after a predetermined period of time; expression synthesis parameters are developed from points on the curve at each time (=emotional parameter), and the developed parameters are used, allowing for variation of expressions by geometrically blending shape data.
